(19) United States
(12) Patent Application Publication
(10) Pub. No.: US 2007/0024403 A1
(43) Pub. Date: Feb. 1, 2007

(54) MEMS switch actuated by the electrostatic force and piezoelectric force

(75) Inventors: Sang-wook Kwon, Seongnam-si (KR); Jun-o Kim, Yongin-si (KR); In-sang Song, Seoul (KR); Sang-hun Lee, Seoul (KR); Dong-kyun Kim, Suwon-si (KR); Hee-moon Jeong, Yongin-si (KR); Young-tack Hong, Suwon-si (KR); Jong-seok Kim, Hwaseong-si (KR); Che-heung Kim, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/439,144

(22) Filed: May 24, 2006

(30) Foreign Application Priority Data
Jul. 27, 2005 (KR) 2005-0068648

(51) Int. Cl. H01H 51/22

(52) U.S. Cl. 335/78; 200/181

(57) ABSTRACT

A MEMS (Micro Electro Mechanical Systems) switch actuated by electrostatic and piezoelectric forces, includes a substrate; a first contact point positioned in a predetermined first area on an upper surface of the substrate; a support layer suspended at a predetermined distance from the upper surface of the substrate; a second contact point formed on a lower surface of the support layer; a first actuator operative to move the support layer in a predetermined direction using an electrostatic force; and a second actuator operative to move the support layer in a predetermined direction using a piezoelectric force. The first actuator is used to turn on the MEMS switch. The second actuator can be used together with the first actuator to turn on the MEMS switch or can be separately used to turn off the MEMS switch. As a result, a stiction can be prevented from occurring between contact points.

### CROSS-REFERENCE TO RELATED APPLICATIONS

This application claims priority under 35 U.S.C. § 119(a) from Korean Patent Application No. 2005-68648, filed Jul. 27, 2005 in the Korean Intellectual Property Office, the entire contents of which are incorporated herein by reference.

### BACKGROUND OF THE INVENTION

1. Field of the Invention

The present invention relates to a MEMS (Micro Electro Mechanical Systems) switch, and more particularly, to a MEMS switch actuated by piezoelectric and electrostatic forces.

2. Description of the Related Art

Portable phones have been popularized with the development of the communication industry. Thus, various types of portable phones have been used in every place of the world. Radio frequency (RF) switches are used in portable phones to distinguish signals in different frequency bands. In the prior art, filter type switches are used. However, leakage signals may be generated between transmitting and receiving nodes. Thus, attempts to use Micro Electro Mechanical Systems (MEMS) fabricated using MEMS technology have been made. MEMS refers to technology for applying semiconductor process technology to fabricate micro-structures.

Such a MEMS switch has a lower insertion loss than an existing semiconductor switch when being turned on and shows a higher attenuation characteristic than the existing semiconductor switch when being turned off. Also, the MEMS switch uses a considerably lower driving power and a considerably higher applied frequency range than the existing semiconductor switch. Thus, the MEMS switch can be applied to about 70 GHz.

Capacities of batteries of compact electronic devices such as portable phones are limited. Thus, a MEMS switch used in a compact electronic device must use a low voltage so as to be normally turned on and/or off. For this purpose, a gap between contact points must be several μm or less. If a power source is connected to the MEMS switch in this case, the MEMS switch is normally turned on. However, if the power source is disconnected from the MEMS switch, a stiction (i.e., static friction) occurs between the contact points. Thus, the MEMS switch is not normally turned off.

Also, it is difficult to fabricate the contact points having the gap of several μm or less. In other words, a sacrificial layer is used to isolate the contact points from each other. Here, a thickness of the sacrificial layer must be several μm or less to realize the gap of several μm or less. In this case, a possibility of the stiction occurring between the contact points is increased in a process of removing the sacrificial layer. As a result, fabricating yield is decreased.

In the prior art, a switch lever is fabricated using a highly stiff material. A stiction phenomenon is prevented to increase a gap between the switch level and a contact point. However, an intensity of a driving voltage for turning on the MEMS switch is increased.

### SUMMARY OF THE INVENTION

Accordingly, non-limiting embodiments of the present invention have been made to address the above-mentioned problems, and an aspect of the non-limiting embodiments is to provide a MEMS switch actuated by piezoelectric and electrostatic forces so as to prevent a stiction (i.e., static friction) between contact points.

According to an aspect of the present invention, there is provided a MEMS (Micro Electro Mechanical Systems) switch including: a substrate; a first contact point positioned in a predetermined first area on an upper surface of the substrate; a support layer suspended at a predetermined distance from the upper surface of the substrate; a second contact point formed on a lower surface of the support layer; a first actuator operative to move the support layer in a predetermined direction using an electrostatic force; and a second actuator operative to move the support layer in a predetermined direction using a piezoelectric force.

In a non-limiting embodiment, if a predetermined first power source is connected to the first actuator, the first actuator may move the support layer toward the substrate so that the second contact point contacts the first contact point. If a predetermined second power source is connected to the second actuator, the second actuator may move the support layer toward an opposite direction to the support layer so as to separate the second contact point from the first contact point.

An operation of connecting the predetermined first power source to the first actuator and an operation of connecting the predetermined second power source to the second actuator may be alternately performed.

Further, the first actuator may include: a first electrode positioned in a predetermined second area on the upper surface of the substrate; and a second electrode positioned in an area of the lower surface of the support layer facing the first electrode and spaced apart from the first electrode.

The second actuator may include: a piezoelectric layer positioned on an upper surface of the support layer; and an actuating electrode positioned on an upper surface of the piezoelectric layer.

The actuating electrode may be an inter-digitated electrode.

According to another aspect of the present invention, if the predetermined second power source is connected to the second actuator, the second actuator may move the support layer toward the substrate so that the second contact point contacts the first contact point.

The predetermined first and second power sources may have an identical intensity.

The second actuator may include: an actuating electrode positioned on the lower surface of the support layer; and a piezoelectric layer positioned on the actuating electrode.

The first actuator may include: a first electrode positioned in a predetermined second area on the substrate; and a second electrode positioned in an area of the piezoelectric layer facing the first electrode and spaced apart from the first electrode.

The support layer may be a cantilever structure comprising a support part contacting the upper surface of the substrate and a protruding part protruding from the support part so as to suspend at a predetermined distance from the upper surface of the substrate.

### BRIEF DESCRIPTION OF THE DRAWINGS

The above aspects and features of the present invention will be more apparent by describing certain non-limiting embodiments of the present invention with reference to the accompanying drawings, in which:

FIG. 1 is a vertical cross-sectional view of an MEMS switch according to a non-limiting embodiment of the present invention;

FIG. 2 is a horizontal cross-sectional view of the MEMS switch shown in FIG. 1;

FIG. 3 is a schematic cross-sectional view illustrating a method of operating a second actuator used in the MEMS switch shown in FIG. 1;

FIG. 4 is a vertical cross-sectional view of a MEMS switch according to another non-limiting embodiment of the present invention; and

FIG. 5 is a vertical cross-sectional view of the MEMS switch of FIG. 1 realized in a cantilever pattern.

### DETAILED DESCRIPTION OF THE ILLUSTRATIVE, NON-LIMITING EMBODIMENTS

Certain non-limiting embodiments of the present invention will be described in greater detail with reference to the accompanying drawings.

In the following description, same drawing reference numerals are used for the same elements even in different drawings. The matters defined in the description such as a detailed construction and elements are provided to assist in a comprehensive understanding of the invention. Thus, it is apparent that the present invention can be carried out without those defined matters. Also, well-known functions or constructions are not described in detail since they would obscure the invention in unnecessary detail.

FIG. 1 is a vertical cross-sectional view of a MEMS switch according to a non-limiting embodiment of the present invention. Referring to FIG. 1, the MEMS switch includes a substrate 110, a first contact point 120, a support layer 130, a second contact point 140, a first actuator 150, and a second actuator 160. The substrate 110 can be implemented generally with a silicon wafer.

The first contact point 120 is formed of a conductive material in a predetermined first area on the substrate 110. If the first contact point 120 is connected to an external signal line (not shown) to turn on the MEMS switch and thus contacts the second contact point 140, the first contact point 120 transmits a signal.

The support layer 130 is spaced apart from an upper surface of the substrate 110 so as to suspend from the substrate 110. The support layer 130 moves toward the substrate 110 or toward an opposite direction to the substrate 110 by the first and second actuators 150 and 160 so as to contact or separate the first and second contact points 120 and 140 from each other. As shown in FIG. 1, the support layer 130 suspends from the upper surface of the substrate 110 but may be supported by the substrate 110. This structure will be described later with reference to FIG. 5.

The second contact point 140 is positioned in an area of a surface (hereinafter referred to as a lower surface) of the support layer 130 facing the substrate 110. The second contact point 140 contacts the first contact point 120 to transmit a signal.

The first and second actuators 150 and 160 each move the support layer 130 toward a predetermined direction. In detail, the first actuator 150 is used to turn on the present MEMS switch, and the second actuator 160 is used to turn off the present MEMS switch.

In other words, a first power source V1 is connected to the first actuator 150, the first actuator 150 moves the support layer 130 toward the substrate 110 so that the second contact point 140 contacts the first contact point 120. For this purpose, the first actuator 150 includes first and second electrodes 151 and 152. The first electrode 151 is positioned in a predetermined second area on the upper surface of the substrate 110. The second electrode 152 is positioned in an area of the lower surface of the support layer 130 facing the first electrode 151. The second and first electrodes 152 and 151 are spaced apart from each other. If the first power source V1 is connected to the first and second electrodes 151 and 152 in this state, an electrostatic force is generated between the first and second electrodes 151 and 152 so as to move the support layer toward the substrate 110.

If a second power source V2 is connected to the second actuator 160, the second actuator 160 moves the support layer 130 toward the opposite direction to the substrate 110. Thus, if the second power source V2 is connected to the second actuator 160 in the contact state between the first and second contact points 120 and 140, the second actuator 160 separates the second contact point 140 from the first contact point 120.

For this purpose, the second actuator 160 includes a piezoelectric layer 161 and an actuating electrode 162. The piezoelectric layer 161 is positioned on one (hereinafter referred to as an upper surface) of both surfaces of the support layer 130 opposite to the substrate 110. The piezoelectric layer 161 may be formed of a piezoelectric material such as AlN, ZnO, or the like. The actuating electrode 162 is positioned on the piezoelectric layer 161. Thus, if the actuating electrode 162 receives the second power source V2, the actuating electrode 162 vibrates horizontal to a surface of the substrate 110 due to a piezoelectric phenomenon of the piezoelectric layer 161. As a result, the actuating electrode 162 lifts the support layer 130 toward the opposite direction to the substrate 110.

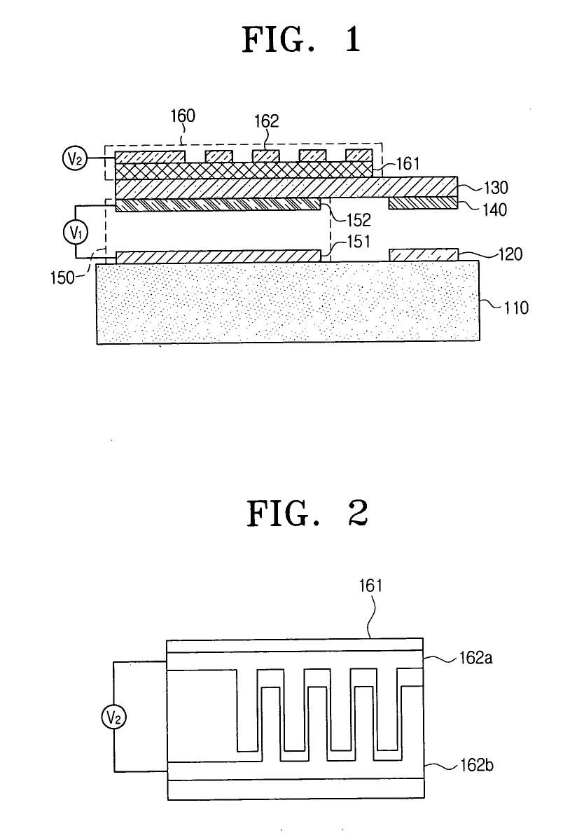

FIG. 2 is a horizontal cross-sectional view of the MEMS switch shown in FIG. 1. Referring to FIG. 2, the second actuator 160 includes the piezoelectric layer 161 and the actuating electrode 162 formed on the piezoelectric layer 161. The actuating electrode 162 includes a first actuating electrode 162a formed in an inter-digitated structure on the piezoelectric layer 161 and a second actuating electrode 162b formed in an inter-digitated structure so as to gear with the first actuating electrode 162a.

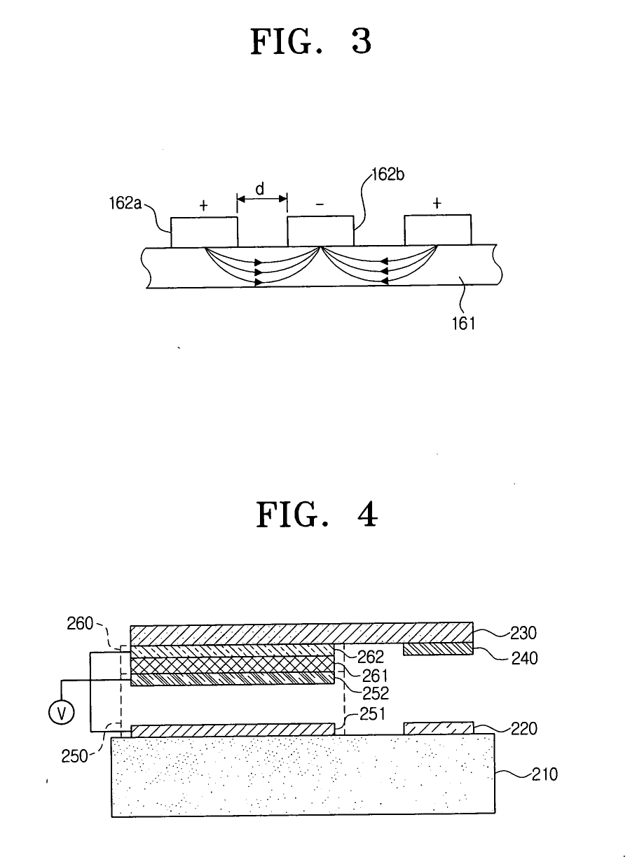

FIG. 3 is a schematic cross-sectional view illustrating a method of operating the second actuator 160 used in the MEMS switch shown in FIG. 1. The actuating electrode 162 is formed in an inter-digitated structure, so as to alternately dispose the first and second actuating electrodes 162a and 162b on the piezoelectric layer 161. If both nodes of the second power source V2 are connected to the first and second electrodes 162a and 162b in this state, a potential difference is formed between the first and second actuating electrodes 162a and 162b. Thus, an electric field is formed inside the piezoelectric layer 161 toward directions indicated by arrows, and thus inter-digitated parts of the first actuating electrode 162a receive a force toward inter-digitated parts of the second actuating electrode 162b. As a result, the piezoelectric layer 161 shrinks in a horizontal direction. Since the piezoelectric layer 161 contacts the upper surface of the support layer 130, the support layer 130 moves upward, i.e., toward the opposite direction to the substrate 110, due to the shrinkage of the piezoelectric layer 161. As a result, the first and second contact points 120 and 140 are separated from each other.

In the MEMS switch shown in FIG. 1, the first and second power sources V1 and V2 are different from each other. Thus, an operation of connecting the first power source V1 to the first actuator 150 and an operation of connecting the second power source V2 to the second actuator 160 may be alternately performed so as to turn on and/or off the MEMS switch. In other words, when the MEMS switch is turned on, the first power source V1 is connected to the first actuator 150. When the MEMS switch is turned off, the first power source V1 is disconnected from the first actuator 150 and the second power source V2 is connected to the second actuator 160 so as to prevent a stiction (i.e., static friction) from occurring.

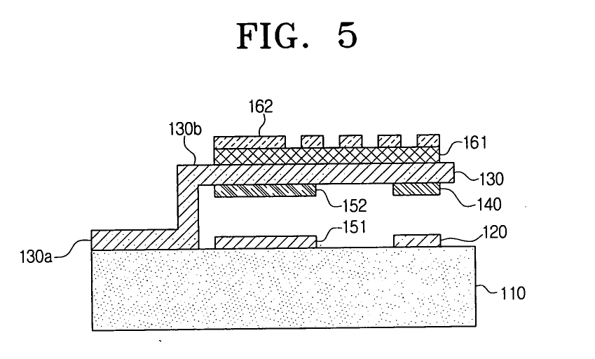

FIG. 4 is a vertical cross-sectional view of an MEMS switch according to another non-limiting embodiment of the present invention. Referring to FIG. 4, the MEMS switch includes a substrate 210, a first contact point 220, a support layer 230, a second contact point 240, a first actuator 250, and a second actuator 260.

In the MEMS switch shown in FIG. 4, the first actuator 250 moves the support layer 230 toward the substrate 210 using an electrostatic force during a connection of a power source V. The second actuator 260 also moves the support layer 230 toward the substrate 210 using a piezoelectric layer during the connection of the power source V. As a result, the piezoelectric and electrostatic forces act at the same time during the connection of the power source V so as to contact the second contact point 240 with the first contact point 220. As shown in FIG. 4, the same power source V is connected to the first and second actuators 250 and 260. However, power sources having different intensities may be connected to the first and second actuators 250 and 260, respectively. Here, the power sources must be connected to the first and second actuators 250 and 260 at the same time. In other words, the power source V is connected to the first and second actuators 250 and 260 at the same time to turn on the MEMS switch. However, the power source V is disconnected from the first and second actuators 250 and 260 at the same time to turn off the MEMS switch.

Structures and functions of the first contact point 220, the support layer 230, and the second contact point 240 shown in FIG. 4 are the same as those of the first contact point 120, the support layer 130, and the second contact point 140 shown in FIG. 1 and thus will not be described herein.

The second actuator 260 includes a piezoelectric layer 261 and an actuating electrode 262. As shown in FIG. 4, the actuating electrode 262 is positioned in an area on a lower surface of the support layer 230. The piezoelectric layer 261 is positioned on the actuating electrode 262.

The first actuator 250 includes first and second electrodes 251 and 252. The first electrode 251 is positioned in a predetermined second area on an upper surface of the substrate 210. The second electrode 252 is positioned on the piezoelectric layer 261 so as to be spaced apart from the first electrode 251.

If the power source V is connected to the first and second electrodes 251 and 252 of the first actuator 250 and the actuating electrode 262 of the second actuator 260, an electrostatic force is generated between the first and second electrodes 251 and 252. Since the power source V is connected to the actuating electrode 262 and the second electrode 252, a piezoelectric phenomenon occurs in the piezoelectric layer 261. Thus, a piezoelectric force acts perpendicular to a surface of the substrate 210. The piezoelectric and electrostatic forces are combined so as to move the support layer 230 toward the substrate 210. As a result, the second contact point 240 contacts the first contact point 220.

In the MEMS switch shown in FIG. 4, the piezoelectric force as well as the electrostatic force acts on the support layer 130 during the connection of the power source V.

Thus, a movement distance of the support layer 130 is increased. As a result, although a gap between the first and second contact points 220 and 240 is great, the MEMS switch may be normally turned on. A restoring force is increased with an increase in the gap. Thus, although the power source V is disconnected, a stiction phenomenon does not occur so as to normally turn off the MEMS switch. Also, the gap between the first and second contact points 220 and 240 does not need to be minute. Thus, the MEMS switch can be easily fabricated, and fabricating yield can be improved.

In the MEMS switches shown in FIGS. 1 and 4, the support layers 130 and 230 may be realized in cantilever structures so as to be supported by the substrates 110 and 210. FIG. 5 is a vertical cross-sectional view of the MEMS switch of FIG. 1 including the support layer 130 realized in a cantilever structure.

The other elements of FIG. 5 except the support layer 130 are as described with reference to FIG. 1 and thus will not be described herein.

Referring to FIG. 5, the support layer 130 is formed in a cantilever structure including a support part 130a and a protruding part 130b. The support part 130a contacts an upper surface of the substrate 110 to support the entire portion of the support layer 130. The protruding portion 130b protrudes from the support part 130a so as to suspend at a predetermined distance from the upper surface of the substrate 110. Thus, the second electrode 152 and the second contact point 140 may be positioned in areas on a lower surface of the protruding part 130b. Also, the piezoelectric layer 161 and the actuating electrode 162 may be sequentially stacked on an upper surface of the protruding part 130b.

If the support layer 130 is formed in a cantilever structure as described above and the first power source V1 is disconnected, a joint portion between the support part 130a and the protruding part 130b operates as a kind of restoring spring so as to provide a restoring force for restoring the support layer 130 that is bent down.

As described above, according to the present invention, an MEMS switch can be turned on and/or off using electrostatic and piezoelectric forces. Thus, a stiction can be prevented from occurring between contact points. Also, according to an aspect of the present invention, a gap between the contact points can be greater than in a conventional MEMS switch actuated by power sources having the same intensity. As a result, the MEMS switch can be easily fabricated, and fabricating yield can be improved.

The foregoing non-limiting embodiments and advantages are merely exemplary and are not to be construed as limiting the present invention. The present teaching can be readily applied to other types of apparatuses. Also, the description of the non-limiting embodiments of the present invention is intended to be illustrative, and not to limit the scope of the claims, and many alternatives, modifications, and variations will be apparent to those skilled in the art.

What is claimed is:

1. An MEMS (Micro Electro Mechanical Systems) switch, comprising:
a substrate;
a first contact point positioned in a predetermined first area on an upper surface of the substrate;
a support layer suspended at a predetermined distance from the upper surface of the substrate;
a second contact point formed on a lower surface of the support layer;
a first actuator operative to move the support layer in a predetermined direction using an electrostatic force; and
a second actuator operative to move the support layer in a predetermined direction using a piezoelectric force.

2. The MEMS switch of claim 1, wherein if a predetermined first power source is connected to the first actuator, the first actuator is operative to move the support layer toward the substrate so that the second contact point contacts the first contact point.

3. The MEMS switch of claim 2, wherein if a predetermined second power source is connected to the second actuator, the second actuator is operative to move the support layer away from the support layer so as to separate the second contact point from the first contact point.

4. The MEMS switch of claim 3, wherein connection between the predetermined first power source to the first actuator and connection between the predetermined second power source to the second actuator is alternately performed.

5. The MEMS switch of claim 3, wherein the first actuator comprises:
a first electrode positioned in a predetermined second area on the upper surface of the substrate; and
a second electrode positioned in an area of the lower surface of the support layer facing the first electrode and spaced apart from the first electrode.

6. The MEMS switch of claim 5, wherein the second actuator comprises:
a piezoelectric layer positioned on an upper surface of the support layer; and
an actuating electrode positioned on an upper surface of the piezoelectric layer.

7. The MEMS switch of claim 6, wherein the actuating electrode is an inter-digitated electrode.

8. The MEMS switch of claim 2, wherein if a predetermined second power source is connected to the second actuator, the second actuator moves the support layer toward the substrate so that the second contact point contacts the first contact point.

9. The MEMS switch of claim 8, wherein the predetermined first and second power sources have an identical intensity.

10. The MEMS switch of claim 8, wherein the second actuator comprises:
an actuating electrode positioned on the lower surface of the support layer; and
a piezoelectric layer positioned on the actuating electrode.

11. The MEMS switch of claim 10, wherein the first actuator comprises:
a first electrode positioned in a predetermined second area on the substrate; and
a second electrode positioned in an area of the piezoelectric layer facing the first electrode and spaced apart from the first electrode.

12. The MEMS switch of claim 1, wherein the support layer is a cantilever structure comprising a support part contacting the upper surface of the substrate and a protruding part protruding from the support part so as to suspend at a predetermined distance from the upper surface of the substrate.
